(19) United States
(12) Patent Application Publication
(10) Pub. No.: US 2026/0210230 A1
(43) Pub. Date: Jul. 23, 2026

(54) FORMATION CHARACTERIZATION USING IMAGES OF WET AND DRY CUTTINGS PARTICLES

(71) Applicant: Schlumberger Technology Corporation, Sugar Land, TX (US)

(72) Inventors: Mahdi Ammar, Dhahran (SA); Can Evren Yarman, Clamart (FR)

(21) Appl. No.: 19/034,897

(22) Filed: Jan. 23, 2025

(51) Int. Cl. E21B 47/002; E21B 44/00; G01B 11/30

(52) U.S. Cl. CPC E21B 47/0025; E21B 44/00; G01B 11/303

(57) ABSTRACT

A method for estimating a characteristic of cuttings particles obtained from a subterranean formation during a drilling operation includes measuring at least first and second bidirectional reflectance distribution functions (BRDFs) of cuttings particles acquired during a drilling operation, the first BRDF measured when the cuttings particles are wet and the second BRDF measured when the cuttings particles are dry and estimating the characteristic of the cuttings particles from the first and second BRDFs.

### CROSS REFERENCE TO RELATED APPLICATIONS

None.

### BACKGROUND

Cuttings particles are produced during drilling operations for oil and gas exploration and recovery, geothermal, and scientific exploration. It will be appreciated that the cuttings particles are abundant in volume and number and may provide one of the lowest cost and most abundant data sources for understanding and characterizing the subsurface rock and formation properties. Cuttings particles have long been evaluated at the surface to generate detailed records of cuttings properties. Moreover, digital images of the cuttings particles are sometimes acquired and later analyzed by offsite geologists. This evaluation is both time consuming and costly.

While the above-described practices for evaluating cuttings particles are commercially serviceable, there is a need for increased automation. In recent years methods have been disclosed for automatically evaluating digital images of cuttings particles using digital image processing and artificial intelligence (AI) techniques to segment individual cuttings particles, classifying cuttings lithology, and estimate formation porosity. While these new methods are promising, there is room for further improvements.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts an example drilling rig including an example system for evaluating cuttings particles.

FIG. 2 depicts a flow chart of an example method for evaluating cuttings particles.

FIG. 3 depicts a flow chart of one example method for acquiring and preparing the cuttings particles evaluated in the method of FIG. 2.

FIG. 4 depicts one example system for taking digital images and measuring the BRDF of the cuttings particles.

FIG. 5 depicts another example system for taking digital images and measuring the BRDF of the cuttings particles.

FIG. 6 depicts a flow chart of one example method for measuring the BRDF of the cuttings particles in the method of FIG. 2.

FIG. 7 depicts a flow chart of another example method for evaluating cuttings particles.

### DETAILED DESCRIPTION

Embodiments of this disclosure include systems and methods for evaluating cuttings particles. One example method includes measuring at least first and second bidirectional reflectance distribution functions (BRDF) of cuttings particles acquired during a drilling operation. The first BRDF is measured when the cuttings particles are wet and the second BRDF is measured when the cuttings particles are dry. Characteristics of the cuttings particles may be estimated from the first and second BRDFs.

Another example method includes taking a digital image of wet cuttings particles acquired during a drilling operation and then simulating a digital image of dry cuttings particles from the digital image of the wet cuttings particles. A characteristic of the cuttings particles may then be estimating from the simulated digital image of dry cuttings particles.

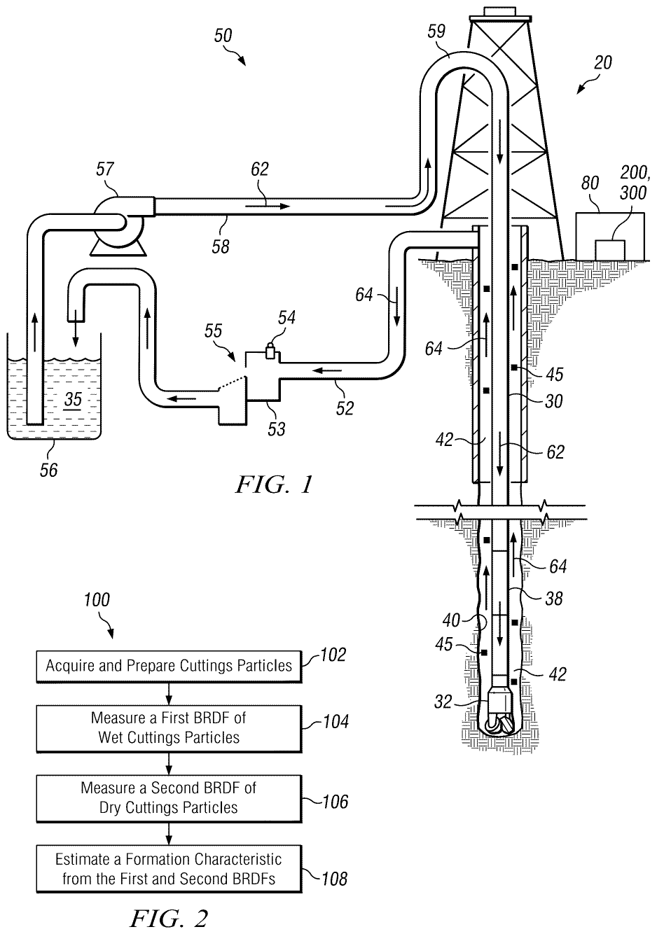

FIG. 1 depicts an example drilling rig 20 including a system 100 for evaluating cuttings particles that are removed from circulating drilling fluid on the rig. The drilling rig 20 may be positioned over a subterranean formation (not shown). The rig 20 may include, for example, a derrick and a hoisting apparatus (also not shown) for raising and lowering a drill string 30, which, as shown, extends into wellbore 40 and includes, for example, a drill bit 32 and one or more downhole measurement tools 38 (e.g., a logging while drilling tool or a measurement while drilling tool) in a bottom hole assembly (BHA) above the bit 32. Suitable drilling systems, for example, including drilling, steering, logging, and other downhole tools are well known in the art.

Drilling rig 20 further includes a surface system 50 for controlling the flow of drilling fluid used on the rig (e.g., used in drilling the wellbore 40). In the example rig depicted, drilling fluid 35 is pumped downhole (as depicted at 62), for example, via a conventional mud pump 57. The drilling fluid 35 may be pumped, for example, through a standpipe 58 and mud hose 59 in route to the drill string 30. The drilling fluid 35 typically emerges from the drill string 30 at or near the drill bit 32 and creates an upward flow 64 of mud through the wellbore annulus 42 (the annular space between the drill string and the wellbore wall). The drilling fluid 35 then flows through a return conduit 52 to a mud pit system 56 where may be recirculated. It will be appreciated that the terms drilling fluid and mud are used synonymously herein.

The circulating drilling fluid 35 is intended to perform many functions during a drilling operation, one of which is to carrying drill cuttings 45 to the surface (in upward flow 64). The drill cuttings 45 are commonly removed from the returning mud via a shale shaker 55 (or other similar solids control equipment) in the return conduit (e.g., immediately upstream of the mud pits 56). Formation gases that are released during drilling may also be carried to the surface in the circulating drilling fluid. These gasses are commonly removed from the fluid, for example, via a degasser or gas trap 54 located in or near a header tank 53 that is immediately upstream of the shale shaker 55 in the example depiction. The drill cuttings 45 may be evaluated to characterize the subterranean formation and/or estimate various properties thereof as described in more detail below.

The rig 20 may include a system 200, 300 configured to take and evaluate digital images of the drill cuttings as described in more detail below. The system 200, 300 may be deployed at the rig site (e.g., in an onsite laboratory 80) or offsite. The disclosed embodiments are not limited in this regard. The system 200, 300 may include computer hardware and software configured to automatically or semi-automatically evaluate the cuttings images. To perform these functions, the hardware may include one or more processors (e.g., microprocessors) which may be connected to one or more data storage devices (e.g., hard drives or solid state memory). As is known to those of ordinary skill, the processors may be further connected to a network, e.g., to receive the images from a networked camera system (not shown) or another computer system. It will, of course, be understood that the disclosed embodiments are not limited the use of or the configuration of any particular computer hardware and/or software.

While FIG. 1 depicts a land rig 20, it will be appreciated that the disclosed embodiments are equally well suited for land rigs or offshore rigs. As is known to those of ordinary skill, offshore rigs commonly include a platform deployed atop a riser that extends from the sea floor to the surface. The drill string extends downward from the platform, through the riser, and into the wellbore through a blowout preventer (BOP) located on the sea floor. The disclosed embodiments are not limited in these regards.

FIG. 2 depicts a flow chart of an example method 100 for evaluating cuttings particles. Cuttings particles are acquired and prepared for imaging at 102. First and second bidirectional reflectance distribution functions (BRDFs) of the cuttings particles are measured at 104 and 106. As described in more detail below, the first BRDF is measured when the cuttings particles are wet and the second BRDF is measured when the cuttings particles are dry. The BRDFs may be measured, for example, by taking multiple digital images of the prepared cuttings particles at corresponding multiple light source illumination angles. The BRDFs are evaluated at 108 to estimate a characteristic of the cuttings particles (and subterranean formation) such as the a lithology and/or a porosity. The evaluation may optionally, but does not necessarily, include the use of AI algorithms.

The BRDF measurements at 104 and 106 are intended to describe the scattering and reflection properties of wet and dry surfaces of the cuttings particles, thereby allowing for the simulation (or modeling) light interactions with the different minerals and surface textures in the particles. Moreover, BRDF measurements may enable the simulation of dry images from images of wet cuttings particles (or images of partially wet or not fully dried cuttings particles). The disclosed methods may therefore advantageously provide enhanced visualization since images of wet particles may suffer from light distortion and reduced clarity due to the presence of surface water films. A suitable simulation may advantageously remove the unwanted effects of surface wetness and provide clearer visualizations of the rock features, such as texture, color, and structural characteristics with improved accuracy. The simulated dry images may further improve consistency in that inconsistencies arising from wetness variations may be removed. The simulated dry images may therefore advantageously provide a consistent baseline for analysis, ensuring that the impact of varying wetness is minimized and facilitating reliable comparisons between different rock samples or different locations.

Moreover, by simulating dry images from wet images, the integrity of the original wet samples may be preserved while still extracting valuable information about their properties. In some cases obtaining additional wet rock samples for analysis may not be feasible due to limitations in sample availability, cost, or logistical constraints. Still further, simulating dry images using BRDF may be done rapidly and cost-effectively, providing geologists with a valuable tool for on-site or real-time analysis. Decision making may therefore be expedited, whether in the field or in the laboratory.

As described in more detail below, measuring BRDF involves using a specialized image acquisition system that illuminates the cuttings particles with controlled lighting conditions and acquires the digital images at multiple illumination angles of a light source. Such an acquisition system enables the collection of precise and detailed data on the directional reflectance properties of the cuttings, allowing for accurate interpretation and analysis. Such images may further enable surface features, such as fractures or weathering patterns, that may not be easily observable with conventional visual images alone to be identified. By quantifying how light is scattered and reflected from the surface of rock cuttings, BRDF measurements provide information about their surface roughness, texture, and optical properties. This data may enable mineral and lithology classification as well as estimation of various rock properties such as porosity, permeability, and wettability.

It will be appreciated that the visual appearance of cuttings particles may vary with varying wetness. For example, increasing wetness may change the color, texture and surface reflectance properties of the particles. One particularly noticeable effect of wetting is that particle surfaces may appear darker and more specular with increasing wetting level. From a color measurement perspective, wetting decreases the color value (i.e., the lightness or darkness of a color) but generally does not change the chroma (i.e., saturation or purity of a color). Moreover, when a cuttings particle is dry, it generally has a certain level of roughness and porosity. These surface irregularities scatter light in different directions, leading to diffuse reflection and a relatively matte appearance. However, when a liquid wets the surface, it may fill the pores and irregularities, altering the light interaction at the surface.

As the wetting level increases, several phenomena contribute to the observed changes in appearance. These include increased surface absorption, specular reflection, and color intensification. Surface absorption may result from the difference in refractive index of the water and rock which may cause greater light penetration and a darker overall appearance of the particles. Increased specular reflection may result from the smoothness of a liquid film. Specular reflection occurs when light reflects off a surface at a particular angle, forming a mirror-like reflection. This can create highlights and glossy areas on the wetted surface, leading to a more specular appearance. In some instances wetting may also enhance or intensify the inherent color of the rock. The presence of water can bring out the natural pigmentation of the minerals present in the rock, making the colors appear more saturated or vibrant. This color intensification is particularly noticeable in rocks with minerals that are more reactive with water. One practical example is that the mineral may exhibit color changes as it reacts with water. For example, during the hydration of hematite, water molecules may enter the crystal structure and lead to changes in its optical properties that can cause color intensification. Moreover, some minerals are moderately or highly soluble with water including gypsum (CaSO₄·2H₂O) and halite (NaCl). Clays are also an important group of minerals that can exhibit varying degrees of solubility or reactivity with water at ambient temperature including smectites (with swelling) and illite and kaolinite (without swelling). The behavior of clays in water can be influenced by factors such as clay mineral composition, and the presence of other ions or organic matter.

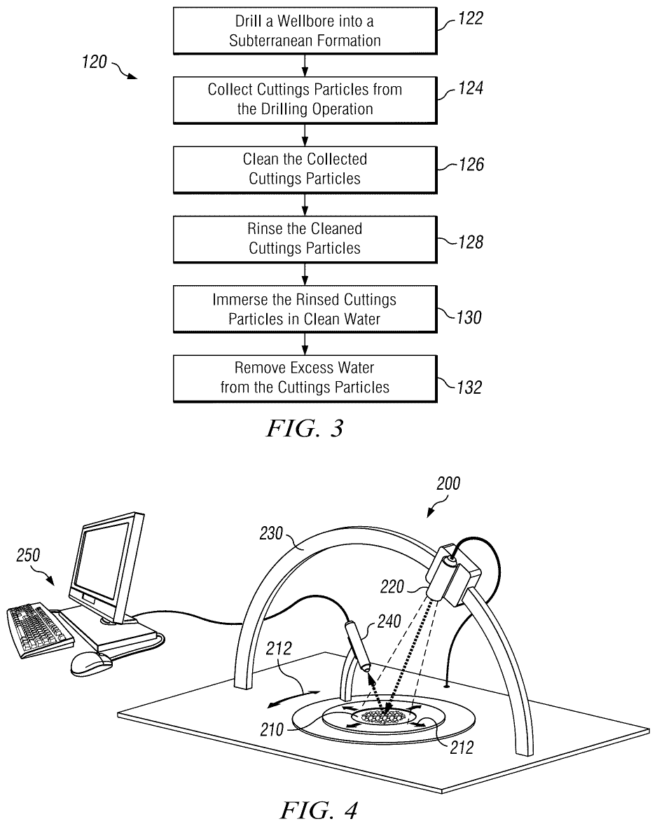

Turning now to FIG. 3, one example method 120 for acquiring and preparing the cuttings particles at 102 of method 100 (FIG. 2) is depicted. A wellbore is drilled into or through a subterranean formation of interest at 122, for example, using the example rig 20 described above with respect to FIG. 1. The cuttings particles generated while drilling are transported to the surface in the upwardly flowing drilling fluid (e.g., as depicted in FIG. 1). The cuttings particles may be collected at 124, for example, using a shale shaker or other solids separation/control equipment. The collected particles are generally contaminated with oil-based mud (OBM) or water-based mud (WBM) such that further preparation may be required.

As further depicted on FIG. 3, the cuttings particles may be cleaned at 126 to remove the contamination. The cuttings particles may be cleaned, for example, in a cleaning solution including a suitable solvent (e.g., acetone, ethanol, isopropyl alcohol, or water) and a detergent or surfactant. The cleaning solution is intended to effectively dissolve or soften drilling fluid or other contaminants that are adhered to the particle surfaces. The cleaning may further include physical abrasion or agitation to promote contaminant removal. Such processes may include, for example, mechanical brushing or scraping, liquid jets, compressed air, and/or ultrasonic agitation. After cleaning the cuttings particles are rinsed with clean water at 128 to remove any residual cleaning solution, detergent, and/or solvent.

The cleaned and rinsed cuttings particles may then be immersed in clean, fresh water for a predetermined time at 130, thereby enabling the cuttings particles to absorb water and reach the natural wet state. This step is intended to simulate in situ moisture conditions and to facilitate accurate characterization of wet rock properties. Excess water may then be removed from the cuttings particles via centrifugation at 132.

FIG. 4 depicts one example system 200 for taking digital images and measuring the BRDF of the cuttings particles. The system 200 includes a sample holder or stage 210 upon which the cuttings particles may be placed. While not depicted, it will be appreciated that the prepared cuttings particles may be placed in a tray or other suitable container and then deployed on the holder 210. The sample holder 210 may advantageously be configured for precise positioning and rotational orientation adjustments as indicated schematically at 212. For example, the sample holder 110 may include stepper motors (not shown) configured to translate the cuttings particles in plane as well as well as rotate the cuttings particles about a central axis (in plane).

With continued reference to FIG. 4, the system 200 may further include a light source 220 such as a diffuse halogen lampor light emitting diode (LED) panel. The light source may be configured to provide consistent (stable) illumination across a desired spectral range. In one example embodiment, the light source 220 may be deployed on a hoop rail 230 that enables precise control of the incident and viewing angles (via changing the illumination angle). In the depicted example embodiment the hoop rail 230 may include the rotating platform for the sample holder 210 and precise angular scales for measuring the angle of incidence of the light source 220. The system 200 further includes a high-resolution digital camera or digital spectrometer 240 to capture and record reflected light from the cuttings particles. A suitable digital camera may include substantially any high-resolution digital camera (or cameras) sensitive to infrared, visible, and/or ultraviolet light. The digital camera may be in electronic communication with a computer system 250 configured to save and evaluate the recorded images.

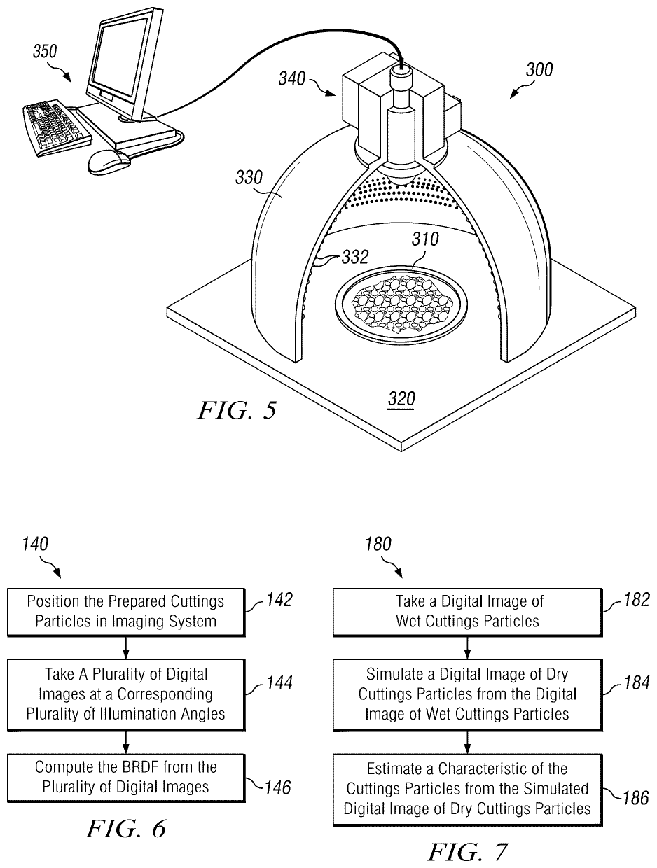

FIG. 5 depicts an alternative system 300 for acquiring the digital images and measuring the BRDF of the cuttings particles. As depicted, the system 300 includes a sample holder 310 deployed on platform 320 (e.g., as described above with respect to FIG. 4). The sample holder 310 may be configured for receiving the cuttings particles and is advantageously flat and free from obstructions. The platform 320 may be optionally configured to rotate about a central axis.

The system 300 includes a dome light 330 including a set of light emitting diodes 332 deployed about an inner surface of the dome light 330. The dome light 330 may include a large number (e.g., a hundred or even several hundred) of the LEDs. The dome light 330 may include LEDs 332 of different colors, such as red, green, and blue. In advantageous embodiments the dome light 330 may include LEDs 332 having eight distinct colors in total. The LEDs 332 may be deployed and configured for individual control (i.e., the LEDs may be illuminated individually) allowing for precise control over the illumination angle (incident angle) of the incoming light. The system 300 further includes a high-resolution digital color camera 340 (e.g. up to 20 megapixels or higher) in electronic communication with a digital controller or computer 350. The camera 340 may be positioned such that it is capable of capturing detailed images at multiple incident angles (in which the cuttings are illuminated using different ones of the LEDs).

With further reference to FIGS. 4 and 5, systems 200 and 300 may be further configured with integrated drying elements to dry the cuttings particles (e.g., drying module 360 in system 300). For example, the systems 200, 300 may include a temperature controller (not shown) deployed in the sample holder. The temperature controller may be configured to provide a controlled and uniform heating to the cuttings particles to promote drying thereof during the imaging process. For example, the heating element may be a resistive heating element. A suitable heating profile may be selected to mimic or promote desired drying conditions. For example the temperature of the sample holder may be gradually increased to promote and simulate the drying process.

Systems 200, 300 may further (or alternatively) employ an infrared or halogen lamp (not shown) that emits intense infrared radiation to promote or facilitate drying. Such a lamp may be advantageously adjustable, for example, using an adjustable power supply or dimmer switch such that a suitable heating profile may be selected to promote the desired drying conditions. In example embodiments, the lamp may be deployed at the apex of dome light 330, for example, directly above the sample holder 310.

System 200, 300 may further (or alternatively) include a fan (not shown) or other mechanism for promoting airflow within the system (and particularly above and around the cuttings particles in the sample holder). The use of a fan may be intended to introduce dry air (and remove humid air) to the cuttings particles and to further promote drying. A humidity sensor may further be deployed in the vicinity of the sample holder to monitor the humidity level and to give an indication of when optimal drying has been achieved.

Turning now to FIG. 6, a flow chart of one example method 140 for measuring the BRDF of the cuttings particles at 104 and 106 of method 100 (FIG. 2) is depicted. The prepared cuttings particles (e.g., wet particles that have been cleaned, rinsed, immersed in water, and had excess water removed via centrifugation) are placed on the sample holder and positioned in an imaging system at 142. For example, the prepared cuttings may optionally be placed in a tray having a high contrast (vivid) background color to enhance subsequent particle identification and segmentation in the acquired images, for example, pure magenta (e.g., with RGB values of 255, 0, 255), pure blue (e.g., with RGB values of 0, 0, 255), pure green (e.g., with RGB values of 0, 255, 0), and so forth. In general, such colors do not exist in nature and, accordingly, help instance segmentation models avoid detecting the background of the tray as part of the particle. Notwithstanding, the tray may be placed on the sample holder in front of the digital camera. Care may be taken to ensure that the sample tray is flat and that there are no obstructions in the imaging system.

A set of digital images may be taken at a plurality of light source illumination angles at 144. For example, when using system 200, the illumination angle may be incremented by rotating the light source along the rail and taking an image at each light source position. For example only, the illumination angle may be incremented at 5 degree increments starting from a perpendicular angle (0 degrees) up to a desired maximum angle (e.g., 30 degrees, 45 degrees, 60 degrees, or 75 degrees). When using system 300 the illumination angle may be incremented by selectively illuminating individual ones or distinct groups of the LEDs and taking a corresponding image when the sample is illuminated with each of the LEDs (or groups of LEDs).

In optional embodiments additional sets of digital images may be taken at 144 at a plurality of distinct sample holder rotational orientations. For example, the sample holder may be rotationally incremented (e.g., at 30 or 45 degree increments) and an image taken at each rotational position. In other optional embodiments additional sets of digital images may be taken at 144 using different colored light sources (light sources having different wavelengths). For example, a first set of digital images may be taken using a light source having a first color, a second set of digital images may be taken using a light source having a second color, and so on. The disclosed embodiments are not limited in these regards.

With reference again to FIG. 2, and continued reference to FIG. 6, the BRDF of the wet and dry cuttings particles may be measured at 104 and 106. For example, when the as prepared particles are wet, a set of digital images may be taken at 144 before drying the particles to measure the BRDF of the wet cuttings particles. After the particles have been sufficiently dried, another set of digital images may be taken at 144 to measure the BRDF of the dry cuttings particles. Moreover, further sets of digital images may be taken at 144 while drying to measure the BRDF of partially dried particles. For example, the initial measurements may be made on the as prepared wet cuttings particles and later measurements may be made on partially dried and then fully dried cuttings particles. The cuttings particles may be dried, for example, via heating and/or forced airflow. For example, the cuttings particles may be deployed on a heated sample holder and/or may be irradiated with a heat lamp. A fan may further promote drying by removing humidity and introducing dry air. The disclosed embodiments are, of course, not limited in these regards.

With reference again to FIG. 2, the BRDF measurements may be evaluated at 206 to extract various properties from the images of the cuttings particles. For example, the images may be evaluated to determine specular and diffuse components representative of particle humidity texture and rock texture. It will be appreciated that the specular component represents the highly directional mirror-like reflection of light from a smooth surface. The diffuse component represents the scattered and diffuse reflection from the rough or textured surface of the cuttings particles. To determine specular components, the BRDF measurements (images) may be evaluated to identify a peak intensity (or peak intensities) at specific incident and viewing angles indicative of specular reflection. Moreover, the intensity and angular position of the specular peak(s) may be evaluated at different wavelengths (colors) and may provide insight into the sample's reflective properties and wavelength dependent behavior of the specular reflection. To determine diffuse components, the BRDF images may be evaluated at various incident and viewing angles to assess light scattering, with the diffuse component having a more spread out and diffuse distribution of reflected light (or broad peaks) as compared to the highly directional specular component. The diffuse component may be quantified by measuring the angular spread or width of the BRDF curve (or reflected peak), for example, by calculating the integral of the BRDF data over a range of angles or by fitting the data to a suitable mathematical model that describes diffuse reflection such as the Lambertian or Oren-Nayar model. The diffuse component may also be evaluated as a function of the incident wavelength to understand wavelength dependent behavior.

Measurements of the specular and diffuse components (and the wavelength dependent specular and diffuse components), may be advantageously utilized to assess drying (and the effectiveness of the drying operation). For example, in the initial measurements (when the particles are wet) the specular reflection component may be strong (have a high intensity) and the diffuse component may be low. As drying progresses and the water content decreases, a reduction in specular reflection may be observed with a corresponding increase in diffuse reflection. By quantifying such changes (or even the disappearance of particular specular peaks), the drying process may be monitored and quantified.

In certain example embodiments, the evaluation described above with respect to 206 in FIG. 2 may be used to provide feedback to the automated image acquisition in 204 and the corresponding for example, such a control system may regulate drying parameters such as temperature, airflow, and/or drying time to achieve a desired reduction in surface water (indicated by a corresponding reduction in specular reflection) while maintaining the integrity of poor water within the cuttings particles.

With still further reference to FIG. 2, the BRDF data may be further evaluated at 206 to extract information about the cuttings particles inclination, roughness, and reflectivity as a function of wavelength (or color). Such evaluation may be particularly well suited for determining characteristics of dried cuttings particles. For example, sample inclination (or the inclination of various particles within the distribution of particles) may be estimated by evaluating variations in the intensity of reflected light at different incident and viewing angles. A broader distribution may indicate a higher inclination angle while a narrower distribution may suggest a flatter surface and lower inclination angle.

Surface roughness may also be estimated by evaluating variations in the intensity of reflected light at different incident and viewing angles. Particles with rougher surfaces tend to exhibit more light scattering, resulting in a broader and more diffuse distribution of reflected light in the BRDF data. Conversely, smoother particles generally produce a narrower and more concentrated distribution of reflected light. Surface roughness may be quantified by analyzing the width or shape of the BRDF curve using a mathematical model such as the Beckmann or Gaussian roughness models.

Particle reflectivity may also be estimated by evaluating variations in the intensity of reflected light at different incident and viewing angles. The BRDF data may be analyzed at each wavelength to determine the reflected light intensity at various incident and viewing angles. Reflectance curves may be determined by plotting the measured reflectivity as a function of wavelength with such a curve representing the sample's spectral reflectance behavior. The particles reflectivity characteristics may be evaluated different wavelengths with peaks or valleys in the curve indicative of absorption or reflection bands related to specific mineral components present in the sample such that the particle mineral content may be estimating from the estimated reflectivity.

The BRDF measurements may be advantageously evaluated to estimate a porosity (or porosity distribution) of the cuttings particles. The porosity or visual porosity affects the interaction of light with the surface of the rock (and therefore impacts the reflected light). As such, porosity may be estimated or evaluated from the BRDF data acquired during the drying process (e.g., from fully wet to fully dry). For example the presence of pores within the cuttings influences the scattering and absorption of light. As drying progresses, the reduction in moisture content affects the distribution and accessibility of water within the pores which further impacts scattering behavior of the light. By analyzing changes in specular and diffuse reflection in the BRDF data during the drying process, the rock porosity may be estimated (or differences in specular and diffuse reflection between wet and dry particles).

The roughness estimated from the BRDF measurements may be further evaluated as an indicator (or proxy) of grain size. The intensity and distribution of scattered light at different angles provides information about the scale and amplitude of surface irregularities, which may be closely related to the grain size of the cuttings particles. In general, higher BRDF roughness values correlate with larger grain sizes while lower BRDF roughness values (smoother surfaces) correlate with smaller grain sizes.

In the context of roughness images, one parameter that can be correlated to grain size is the average height or amplitude of surface irregularities. This parameter, often referred to as root mean square (RMS) roughness, provides a quantitative measure of the overall height variations on the surface. In general, larger grain sizes are associated with rougher surfaces and higher RMS roughness values, indicating greater height differences between adjacent grains. Other roughness parameters may also be correlated with grain size, such as skewness, autocorrelation, and fractal dimension. Skewness measures the asymmetry of the height distribution with a positive skewness indicating an abundance of higher peaks, which may correlate with larger grain sizes. Autocorrelation measures the spatial correlation between height values and may therefore provide an estimate of an average grain size. Moreover, fractal analysis examines the self-similarity or complexity of the surface, which can be correlated to grain size, with higher values indicating finer (smaller) grains and lower values suggesting coarser (larger) grains.

With yet further reference to FIG. 2, drying decay curves may be evaluated as an indicator of cuttings wettability at 206. The presence of specular reflections in the BRDF data may indicate the degree of water repellency or non-wettability of the rock surface. A surface with higher specular reflection m be the result of water beating up and sliding off the surface, thereby indicating hydrophobic or water repellent behavior. Conversely, a surface with lower specular reflection may indicate that water spreads and adheres to the surface, thereby suggesting hydrophilic or water attracting behavior. The surface roughness of the cuttings particles may also influence water wettability, with smoother surfaces tending to exhibit higher specular reflection and a greater likelihood of water repellency. Rougher surfaces tend to exhibit lower specular reflection and have a greater tendency to interact with water.

The rock properties may be advantageously further evaluated to classify the formation lithology. For example, the reflectivity, color, roughness, and drying data estimated from the BRDF data may enable carbonates, claystones, and sandstones to be differentiated based on their distinct characteristics. As such, evaluating the BRDF images at 206 may further include classifying or characterizing the lithology of the cuttings particles before assigning a lithology to individual particles within the image.

Reflectivity refers to the amount or intensity of light that is reflected from the surface of the particles. Carbonates generally exhibit higher reflectivity owing to their crystalline nature and higher mineral content. Claystones commonly have lower reflectivity as they contain a higher proportion of clay minerals. Sandstones may vary in reflectivity, but the presence of minerals like quartz may enhance the reflectivity.

Color may provide valuable information about the mineral composition of the cuttings particles. Carbonates commonly appear in shades of white, gray, or light brown, depending on the presence of impurities. Clay stones tend to have colors ranging from gray to brown or reddish, reflecting the mineralogy of the clay minerals. Sandstones exhibit a wide range of colors depending on the mineral composition, with hues of red, yellow, brown, or gray being common.

Roughness, which refers to the texture or surface irregularities as described above, may also provide valuable information about the lithology of the cuttings particles. Carbonates typically have smooth surfaces owing to their compact and crystalline nature. Clay stones often exhibit a fine-grained, smooth texture. Sandstones, on the other hand, generally display a coarser and more granular texture owing to the presence of sand-sized grains.

The drying behavior of the cuttings particles may also provide valuable insights into their water absorption and retention properties. Carbonates tend to dry relatively quickly due to their low porosity and permeability. Claystones have high water retention capacity and dry slowly, resulting in longer drying times. Sandstones exhibit intermediate drying behavior due to their moderate porosity.

Table 1 summarizes the above lithology information.

TABLE 1

| Parameter | Carbonates | Claystones | Sandstones |
|---|---|---|---|
| Reflectivity | Higher | A lower | Variable |
| | reflectivity owing | reflectivity | reflectivity, |
| | to crystalline | owing to | enhanced by |
| | nature and mineral | higher clay | minerals |
| | content | mineral content | such as quartz |
| Color | Shades of white, | Gray to | Wide range |
| | gray, or | brown or | of colors |
| | light brown | reddish | (red, yellow, |
| | | | brown, gray) |
| Roughness | Smoother | Fine-grained | Coarser and more |
| | surface | smooth texture | granular texture |
| Drying | Quick drying | Slow drying | Intermediate drying |
| Behavior | owing to low | owing to high | behavior owing to |
| | porosity | water retention | moderate porosity |
| | and permeability | capacity | |

As described above with respect to FIG. 2, the disclosed embodiments may enable images of dry cuttings particles to be simulated from images of wet or partially wet cuttings particles. The disclosed embodiments may therefore advantageously provide enhanced visualization since images of wet particles may suffer from light distortion and reduced clarity due to the presence of surface water films. The simulation may advantageously remove the unwanted effects of surface wetness and provide clearer visualizations of the rock features, such as texture, color, and structural characteristics with improved accuracy. In example embodiments, simulating an image of dry cuttings particles may include increasing the luminance (also referred to as brightness or ‘L’ value) of the image. For example, it has been found, particularly for sandstone, that the dominant effect of drying is to increase the L value of the image. Moreover, it has been found that the L value tends to undergo a sharp transition (with drying) that occurs when water filling the pores and surface texture of the rock evaporates. For sandstone, and other lithologies that do not react with water, drying tends to have little impact on image color (hue). Still further, it has been found that the magnitude of the L value increase depends upon the porosity and/or surface roughness of the rock with a larger increase (change) being observed for rocks having a larger visual porosity. It will therefore be appreciated that the porosity (or visual porosity) may be estimated during a drying experiment (e.g., as described above with respect to FIG. 2).

With continued reference to FIG. 2, color changes (e.g., hue or chroma) have been observed for lithologies that interact or react with the water. For example, drying wet shale particles has been observed to sharply increase the L value as described above and to also decrease the average (mean) hue at about the same drying level at which the L value increase is observed. This change in mean hue may be related to swelling of the shale with water saturation such that the decrease in the hue may occur when the swelling is reversed. In example embodiments in which the cuttings particles include shale, simulating an image of dry cuttings particles may include increasing the L value and correspondingly decreasing the hue. Color changes may also be observed for other rock types, such as salts or hematite, that may react with the water.

With continued reference to FIG. 2, it will be appreciated that method 100 may be used to calibrate a wet to dry simulation model for a particular formation or a particular type of particles. For example, L value or hue changes may be quantified and may then be applied to images of wet, partially wet, or not fully dried particles. The simulated images may then be further evaluated, for example, as described above to estimate various properties of the cuttings particles, such as the lithology and/or the porosity.

FIG. 7 depicts a flow chart of another method 180 for estimating a characteristic of cuttings particles obtained from a subterranean formation during a drilling operation. The method 180 includes taking a digital image of wet cuttings particles at 182. The digital image may be taken, for example, using a digital camera as described above and may include one or more images at corresponding illumination directions. The cuttings particles may be acquired during a drilling, for example, as also described above. In one example embodiment, the cuttings particles may be collected from circulating drilling fluid (e.g., via a shale shaker), washed, rinsed, and immersed in water. Excess water may then be removed, for example, via centrifugation.

Method 180 further includes simulating a digital image of dry cuttings particles at 184 from the digital image of the wet cuttings particles (taken at 182). In example embodiments, the simulation may include increasing a luminance of the digital image of the wet cuttings particles. In other example embodiments, the simulation may include increasing a luminance and decreasing a hue of the digital image of the wet cuttings particles. A characteristic of the cuttings particles may then be estimated at 186 from the simulated image of dry cuttings particles. As described above, the characteristic of the cuttings particles may include one or more of a porosity, a surface roughness, a grain size, a mineral content, and a lithology.

It will be understood that the present disclosure includes numerous embodiments. These embodiments include, but are not limited to, the following embodiments.

In a first embodiment, a method for estimating a characteristic of cuttings particles obtained from a subterranean formation during a drilling operation comprises measuring at least first and second bidirectional reflectance distribution functions (BRDFs) of cuttings particles acquired during a drilling operation, the first BRDF measured when the cuttings particles are wet and the second BRDF measured when the cuttings particles are dry; and estimating the characteristic of the cuttings particles from the first and second BRDFs.

A second embodiment may include the first embodiment, wherein measuring the at least first and second BRDFs comprises: drilling a subterranean wellbore; collecting the cuttings particles from circulating drilling fluid; preparing the cuttings particles; taking a first set of digital images of the prepared cuttings particles when wet, the first set of digital images comprising a first plurality of digital images taken at a corresponding plurality of light source illumination angles; and taking a second set of digital images of the prepared cuttings particles when dry, the second set of digital images comprising a second plurality of digital images taken at the corresponding plurality of light source illumination angles.

A third embodiment may include the second embodiment, wherein the first set of digital photographs and the second digital photographs are each taken at first and second different colors.

A fourth embodiment may include any one of the second and third embodiments, further comprising taking a third set of digital images of the prepared cuttings particles when at an intermediate state between the wet and the dry, the third set of digital images comprising a third plurality of digital images taken at the corresponding plurality of angles of incidence of the light source.

A fifth embodiment may include the fourth embodiment, wherein the prepared cuttings particles are wet; the method further comprises drying the prepared cuttings particles; the first set of digital images are taken of the cuttings particles prior to the drying; the second set of digital images are taken of the cuttings particles after the drying; and the third set of digital images are taken of the cuttings particles during the drying.

A sixth embodiment may include any one of the first through fifth embodiments, wherein the measuring and the estimating are performed automatically.

A seventh embodiment may include any one of the first through sixth embodiments, wherein the estimating the characteristic of the cuttings particles further comprises: estimating first specular and diffuse reflection components for the wet cuttings particles from the first measured BRDF; estimating second specular and diffuse reflection components for the dry cuttings particles from the second measured BRDF; and estimating a porosity of the cutting particles from a difference between the first and second specular and diffuse reflection components.

An eighth embodiment may include any one of the first through seventh embodiments, wherein the estimating the characteristic of the cuttings particles further comprises: estimating a surface roughness of the cuttings particles from the first and second measured BRDF; and estimating a grain size of the cuttings particles from the estimated surface roughness.

A ninth embodiment may include any one of the first through eighth embodiments, wherein the estimating the characteristic of the cuttings particles further comprises: estimating a reflectivity of the cuttings particles from the first and second measured BRDF; and estimating a mineral content of the cuttings particles from the estimated reflectivity.

A tenth embodiment may include any one of the first through ninth embodiments, wherein the estimating the characteristic of the cuttings particles further comprises: estimating reflectivity, color, roughness, and drying behavior of the cuttings particles from the first and second measured BRDF; and classifying the cuttings particles as one of carbonates, claystones, and sandstones based on the estimated reflectivity, color, roughness, and drying behavior.

In an eleventh embodiment, a system for estimating a characteristic of cuttings particles obtained from a subterranean formation during a drilling operation comprises a sample holder configured to receive cuttings particles; a digital camera positioned and configured to record digital images of the cuttings particles on the sample holder; a light source configured to illuminate the sample holder at a selected plurality of illumination angles; a drying module configured to dry the cuttings particles on the sample holder; and a controller configured to (i) cause the digital camera to measure first and second bidirectional reflectance distribution functions (BRDF) of the cuttings particles, the first BRDF measured when the cuttings particles are wet and the second BRDF measured when the cuttings particles are dry; and (ii) estimate a characteristic of a subterranean formation from the first and second BRDFs.

A twelfth embodiment may include the eleventh embodiment, wherein the drying module comprises a resistive heating element deployed in the sample holder or a heat lamp configured to configured to illuminate the cuttings particles on the sample holder.

A thirteenth embodiment may include any one of the eleventh through twelfth embodiments, wherein the light source comprises a dome light including at least 100 individually controllable light emitting diodes (LEDs) deployed about an interior of a dome, the individually controllable LEDs configured to illuminate the cuttings particles on the sample holder.

A fourteenth embodiment may include any one of the eleventh through thirteenth embodiments, wherein the controller is configured to cause the digital camera to measure the first and second BRDFs by taking a first set of digital images of the cuttings particles when the cuttings particles are wet, the first set of digital images comprising a first plurality of digital images taken at a corresponding plurality of illumination angles of the light source and taking a second set of digital images of the cuttings particles when the cuttings particles are dry, the second set of digital images comprising a second plurality of digital images taken at the plurality of illumination angles of the light source.

A fifteenth embodiment may include any one of the eleventh through fourteenth embodiments, wherein the controller is configured to estimate first specular and diffuse reflection components for the wet cuttings particles from the first measured BRDF, estimate second specular and diffuse reflection components for the dry cuttings particles from the second measured BRDF, and estimate a porosity of the cutting particles from a difference between the first and second specular and diffuse reflection components.

In a sixteenth embodiment, a method for estimating a characteristic of cuttings particles obtained from a subterranean formation during a drilling operation comprises taking a digital image of wet cuttings particles acquired during a drilling operation; simulating a digital image of dry cuttings particles from the digital image of the wet cuttings particles; and estimating the characteristic of the cuttings particles from the simulated digital image of dry cuttings particles.

A seventeenth embodiment may include the sixteenth embodiment wherein the simulating comprises increasing a luminance of the digital image of the wet cuttings particles.

An eighteenth embodiment may include the seventeenth embodiment wherein the simulating further comprises decreasing a hue of the digital image of the wet cuttings particles.

A nineteenth embodiment may include any one of the sixteenth through eighteenth embodiments, wherein taking the digital image of the wet cuttings particles further comprises: drilling a subterranean wellbore; collecting the cuttings particles from circulating drilling fluid; washing the collected cuttings particles; rinsing the washed cuttings particles; immersing the rinsed cuttings particles in water; removing excess water from the cuttings particles to obtain the wet cuttings particles; and taking the digital image of the wet cuttings particles.

A twentieth embodiment may include any one of the sixteenth through nineteenth embodiments wherein the characteristic of the cuttings particles comprises at least one of a porosity, a surface roughness, a grain size, a mineral content, and a lithology.

Although formation characterization using images of wet and dry cuttings has been described in detail, it should be understood that various changes, substitutions and alternations can be made herein without departing from the spirit and scope of the disclosure as defined by the appended claims.

1. A method for estimating a characteristic of cuttings particles obtained from a subterranean formation during a drilling operation, the method comprising:
measuring at least first and second bidirectional reflectance distribution functions (BRDFs) of cuttings particles acquired during a drilling operation, the first BRDF measured when the cuttings particles are wet and the second BRDF measured when the cuttings particles are dry; and
estimating the characteristic of the cuttings particles from the first and second BRDFs.

2. The method of claim 1, wherein measuring the at least first and second BRDFs comprises:
drilling a subterranean wellbore;
collecting the cuttings particles from circulating drilling fluid;
preparing the cuttings particles;
taking a first set of digital images of the prepared cuttings particles when wet, the first set of digital images comprising a first plurality of digital images taken at a corresponding plurality of light source illumination angles; and
taking a second set of digital images of the prepared cuttings particles when dry, the second set of digital images comprising a second plurality of digital images taken at the corresponding plurality of light source illumination angles.

3. The method of claim 2, wherein:
the first set of digital photographs and the second digital photographs are each taken at first and second different colors.

4. The method of claim 2, further comprising:
taking a third set of digital images of the prepared cuttings particles when at an intermediate state between the wet and the dry, the third set of digital images comprising a third plurality of digital images taken at the corresponding plurality of angles of incidence of the light source.

5. The method of claim 4, wherein:
the prepared cuttings particles are wet;
the method further comprises drying the prepared cuttings particles;
the first set of digital images are taken of the cuttings particles prior to the drying;
the second set of digital images are taken of the cuttings particles after the drying; and
the third set of digital images are taken of the cuttings particles during the drying.

6. The method of claim 1, wherein the measuring and the estimating are performed automatically.

7. The method of claim 1, wherein the estimating the characteristic of the cuttings particles further comprises:
estimating first specular and diffuse reflection components for the wet cuttings particles from the first measured BRDF;
estimating second specular and diffuse reflection components for the dry cuttings particles from the second measured BRDF; and
estimating a porosity of the cutting particles from a difference between the first and second specular and diffuse reflection components.

8. The method of claim 1, wherein the estimating the characteristic of the cuttings particles further comprises:
estimating a surface roughness of the cuttings particles from the first and second measured BRDF; and
estimating a grain size of the cuttings particles from the estimated surface roughness.

9. The method of claim 1, wherein the estimating the characteristic of the cuttings particles further comprises:
estimating a reflectivity of the cuttings particles from the first and second measured BRDF; and
estimating a mineral content of the cuttings particles from the estimated reflectivity.

10. The method of claim 1, wherein the estimating the characteristic of the cuttings particles further comprises:
estimating reflectivity, color, roughness, and drying behavior of the cuttings particles from the first and second measured BRDF; and
classifying the cuttings particles as one of carbonates, claystones, and sandstones based on the estimated reflectivity, color, roughness, and drying behavior.

11. A system for estimating a characteristic of cuttings particles obtained from a subterranean formation during a drilling operation, the system comprising:
a sample holder configured to receive cuttings particles;
a digital camera positioned and configured to record digital images of the cuttings particles on the sample holder;
a light source configured to illuminate the sample holder at a selected plurality of illumination angles;
a drying module configured to dry the cuttings particles on the sample holder; and
a controller configured to (i) cause the digital camera to measure first and second bidirectional reflectance distribution functions (BRDF) of the cuttings particles, the first BRDF measured when the cuttings particles are wet and the second BRDF measured when the cuttings particles are dry; and (ii) estimate a characteristic of a subterranean formation from the first and second BRDFs.

12. The system of claim 11, wherein the drying module comprises a resistive heating element deployed in the sample holder or a heat lamp configured to configured to illuminate the cuttings particles on the sample holder.

13. The system of claim 11, wherein the light source comprises a dome light including at least 100 individually controllable light emitting diodes (LEDs) deployed about an interior of a dome, the individually controllable LEDs configured to illuminate the cuttings particles on the sample holder.

14. The system of claim 11, wherein the controller is configured to cause the digital camera to measure the first and second BRDFs by taking a first set of digital images of the cuttings particles when the cuttings particles are wet, the first set of digital images comprising a first plurality of digital images taken at a corresponding plurality of illumination angles of the light source and taking a second set of digital images of the cuttings particles when the cuttings particles are dry, the second set of digital images comprising a second plurality of digital images taken at the plurality of illumination angles of the light source.

15. The system of claim 11, wherein the controller is configured to estimate first specular and diffuse reflection components for the wet cuttings particles from the first measured BRDF, estimate second specular and diffuse reflection components for the dry cuttings particles from the second measured BRDF, and estimate a porosity of the cutting particles from a difference between the first and second specular and diffuse reflection components.

16. A method for estimating a characteristic of cuttings particles obtained from a subterranean formation during a drilling operation, the method comprising:
taking a digital image of wet cuttings particles acquired during a drilling operation;
simulating a digital image of dry cuttings particles from the digital image of the wet cuttings particles; and
estimating the characteristic of the cuttings particles from the simulated digital image of dry cuttings particles.

17. The method of claim 16, wherein the simulating comprises increasing a luminance of the digital image of the wet cuttings particles.

18. The method of claim 17, wherein the simulating further comprises decreasing a hue of the digital image of the wet cuttings particles.

19. The method of claim 16, wherein taking the digital image of the wet cuttings particles further comprises:
drilling a subterranean wellbore;
collecting the cuttings particles from circulating drilling fluid;
washing the collected cuttings particles;
rinsing the washed cuttings particles;
immersing the rinsed cuttings particles in water;
removing excess water from the cuttings particles to obtain the wet cuttings particles; and
taking the digital image of the wet cuttings particles.

20. The method of claim 16, wherein the characteristic of the cuttings particles comprises at least one of a porosity, a surface roughness, a grain size, a mineral content, and a lithology.
